(19) United States
(12) Patent Application Publication
(10) Pub. No.: US 2004/0025326 A1
(43) Pub. Date: Feb. 12, 2004

(54) Merge comb inspection apparatus and method

(76) Inventor: Michael W. Pfeiffer, Savage, MN (US)

Correspondence Address: Mitchell K. McCarthy, Seagate Technology LLC, Intellectual Property - OKM270, 10321 West Reno, Oklahoma City, OK, 73127-7140, US

(21) Appl. No.: 10/454,904

(22) Filed: Jun. 4, 2003

Related U.S. Application Data
(60) Provisional application No. 60/401,677, filed on Aug. 7, 2002.

(51) Int. Cl. G11B 5/127; B23P 19/00

(52) U.S. Cl. 29/603.03; 29/737

(57) ABSTRACT

A head disc merge assembly for merging an actuator with a disc stack, the actuator assembly having a flexure supporting a data transducer head and the disc stack having a disc, the head disc merge assembly including a merge comb having a flexure support member to support the flexure at a predetermined elevation with respect to the disc while positioning the data transducer head on the disc. A merge comb inspection station is provided having an edge detector device for determining selected dimensional values of the merge comb, and a comparator determines whether the merge comb effects clearing engagement of the actuator with the disc stack prior to each merge cycle.

### RELATED APPLICATIONS

This application claims priority to U.S. Provisional Application No. 60/401,677 filed Aug. 7, 2002 entitled Method and Apparatus For Inspecting Merge Comb.

### FIELD OF THE INVENTION

The claimed invention relates generally to disc drive data storage devices and more particularly to an apparatus and method for automatically inspecting a merge comb for a disc drive.

### BACKGROUND

Disc drives are digital data storage devices that store and retrieve large amounts of user data in a fast and efficient manner. The data are magnetically recorded on the surfaces of one or more rigid data storage discs affixed to a spindle motor for rotation at a constant high speed. The discs and spindle motor are commonly referred to as a disc stack.

The disc stack is accessed by an array of vertically aligned data transducer heads that are controllably positioned by an actuator assembly. Each head typically includes electromagnetic transducer read and write elements that are carried on a fluid bearing slider. The fluid can be air or alternatively a fluid such as helium. The slider acts in a cooperative hydrodynamic relationship with a thin layer of fluid dragged along by the spinning discs to fly each head in a closely spaced relationship to the disc surface.

In order to maintain the proper flying relationship between the heads and the discs, the heads are attached to and supported by flexible suspension assemblies, also called flexures. An actuator motor, typically a voice coil motor (VCM), rotates the actuator assembly to cause the heads to move across the disc recording surfaces. The actuator assembly is also referred to as a head stack assembly (HSA). Both the disc stack and the head stack assembly are mounted to and supported by a rigid base deck of the drive.

Disc drives are typically manufactured using high volume automated assembly lines. In a typical automated line, the drives are assembled on pallets conveyed to various assembly stations, each station adding a different set of components to, or performing a different operation on, the drives.

One such station commonly found in a typical automated assembly line is a head disc merge station in which a head stack assembly is merged with a disc stack. “Merge” in this context refers to the insertion and positioning of the heads into the disc stack, that is, positioning the heads between and adjacent to the discs in their final assembled relationship.

In some merge stations the head stack assembly and the disc stack are merged, following which the merged head stack assembly and disc stack are together mounted to the base deck. In other merge stations, the sequence of assembly is to mount the disc stack to the base deck; mount the head stack assembly to the base deck with the heads at a position outside the outermost diameter of the disc stack; and rotate the head stack assembly to merge the heads into the disc stack.

Typically, at the conclusion of a merge operation, the heads are positioned near an innermost diameter of the disc stack, resting against textured landing zones on the disc surfaces. The landing zones provide reduced stiction forces between the heads and discs to allow the heads to safely park during non-operation of the drive.

A latching arrangement secures the head stack assembly when the heads are parked to prevent the heads from inadvertently contacting the data recording surfaces in response to the application of a mechanical shock to the drive, since allowing the heads to contact the data recording surfaces when the discs are not rotating can damage the drive.

It is thus necessary to support the heads above the respective disc surfaces during the merge operation as the heads are positioned in the final park position. Some have proposed applying power to the spindle motor to rotate the discs and powering the actuator motor so that the heads are supported by disc rotation fluid bearings during the merge operation. Usually, however, the merge operation is performed with stationary discs and while the heads are supported as the heads are advanced to the park position.

Head stack assemblies are typically purchased from a head stack assembly manufacturer and are provided with removable shipping spacers. The shipping spacers are comb-like structures that support the flexures to protect the heads from inadvertent contact with each other and prevent deformation of the flexures during shipping and handling.

During a typical merge operation, a merge comb, or merge spreader, is inserted into the head stack assembly at the merge station to provide appropriate spacing between the heads. The spacer comb is removed once the merge comb engages the flexures and the heads are advanced to the final park position.

Usually, the merge comb supports the flexures and the heads as the heads are moved from the outermost diameter of the discs to the innermost diameter of the discs in such a manner that contact is prevented between the disc stack and either the merge comb or head stack assembly until the merge comb releases the heads in the final park position. Once the heads are parked, the merge comb is retracted and the merge operation cycle is completed.

The merge combs can become bent or otherwise damaged. Thus, it has been necessary to implement an inspection routine to minimize or avoid the damage that occurs with unwanted contact between the merge comb and the disc stack. Otherwise, expensive rework or component replacement is risked.

Some merge comb inspection methods include go/no go gages applied by an assembly operator prior to the merge operation cycle. This is time consuming, as well as being subjective to operator judgment. Another merge comb inspection method is that of removing the merge comb from the merge station and subjecting the merge comb to traditional inspection routines. Again, however, this latter mentioned merge inspection method is time consuming. Any improved quality from the methods comes at the cost of reduced production rates.

There is therefore a continuing need for an accurate and fast method and apparatus to inspect a head disc merge comb to avoid damage to disc stacks, and to address other limitations associated with the current state of the art.

### SUMMARY OF THE INVENTION

In accordance with preferred embodiments, an apparatus and method are provided to merge a head disc merge assembly for merging a disc stack assembly with a disc stack, the head stack assembly having at least one flexure supporting a data transducer head and the disc stack having at least one disc with a data storage surface.

The head disc merge assembly has a merge comb with a merge arm which engages and supports the flexure at an elevation determined to establish a clearing relationship between the head and the disc as the flexure and head are moved adjacent the disc storage surface. A merge comb inspection device is provided to inspect the merge arm, between each merging cycle, measuring same to assure the existence of adequate clearing relation between the merge arm and the disc stack.

The merge comb is configured to position the head at a textured landing zone on the data storage surface, and upon retraction of the merge comb, to place the head in its park position. Further, the merge comb inspection device has an edge detector and means moving the merge comb relative to the edge detector to inspect selected dimensions of the merge comb. A comparator, responsive to the edge detector, determines whether the merge comb has clearing engagement the disc stack in accordance with predetermined specifications. Preferably, the comparator sends the inspection determinations to a visual monitor to provide notification as to an in specification (spec) or out of specification condition of the merge comb.

The method of the claimed invention is generally directed to steps including the actuator assembly being moved to a head disc merge assembly station at which is a merge comb with a merge arm for engaging and supporting the flexure at an elevation sufficient to establish a clearing relationship between the head and the disc as the data transducer head is moved adjacent the data storage surface.

The merge comb is moved to an inspection station where selected dimensional values are determined, and these dimensional values are compared to nominal values to determine whether acceptable merge comb elevations will be effected. If so, the step of aligning and engaging the merge comb and the actuator assembly follow, after which the merge comb and actuator are moved to merge the actuator assembly with the disc stack.

If unacceptable merge comb elevations are determined in the comparing step, the merge comb is replaced and the replacement merge comb is subjected to the inspecting and comparing steps until acceptable merge comb elevations are found, following which the step of aligning and engaging the merge comb and the actuator assembly follows, and the merge comb and actuator are moved to merged the actuator assembly with the disc stack.

These and various other features and advantages which characterize the claimed invention will become apparent upon reading the following detailed description and upon reviewing the associated drawings.

### BRIEF DESCRIPTION OF THE DRAWINGS

FIG. 1 is a top plan view of a disc drive constructed in accordance with preferred embodiments of the present invention.

FIG. 2 is a top plan view of the actuator assembly of the disc drive of FIG. 1 having a shipping spacer thereon, the shipping spacer protecting the actuator assembly during shipping and handling prior to installation into the disc drive.

FIG. 3 is an elevational, partial cross-sectional view of the actuator assembly and the shipping spacer of FIG. 2.

FIG. 4 is a top plan view of a merge comb that is used to merge the actuator assembly with the disc stack of the disc drive of FIG. 1 in accordance with preferred embodiments.

FIG. 5 is a partial elevational view of the merge comb of FIG. 4.

FIG. 6 is a flow chart that is generally illustrative of the steps of a head disc and disc stack merge operation. FIG. 6A is a flow chart showing a head disc and disc stack merge operation having a head disc merge assembly station, and which is constructed in accordance with preferred embodiments of the present invention.

FIGS. 7 through 10 show the disc stack and actuator assembly at various stages of a head disc merge operation.

FIG. 11 is a diagrammatical representation of a merge inspection station constructed in accordance with preferred embodiments of the present invention.

FIG. 12 is a view of the screen of a readout monitor of the merge inspection station of FIG. 11.

### DETAILED DESCRIPTION

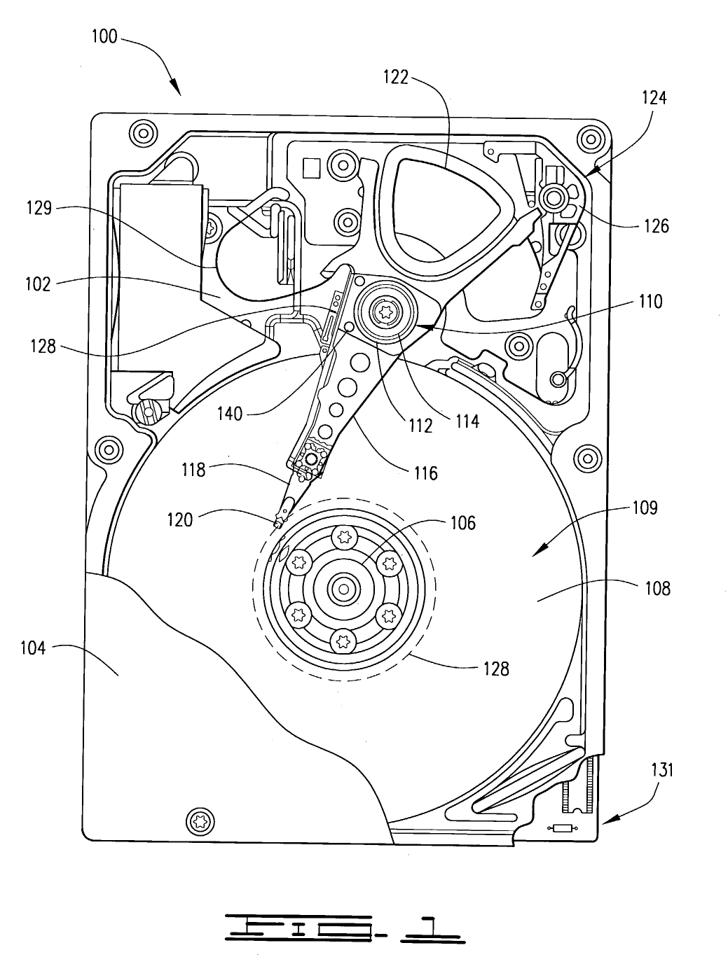

FIG. 1 is a top plan view of a disc drive 100 constructed in accordance with preferred embodiments of the present invention. A base deck 102 and a top-cover 104 (partially cutaway in this view) cooperate to form a sealed housing for the disc drive 100. A spindle motor 106 is supported by the base deck 102 and serves to support and rotate a number of magnetic recording discs 108 at a constant, high speed.

The discs 108 are stacked on a rotatable hub of the spindle motor 106 in a conventional fashion using suitable spacers and clamping elements (not separately designated). The spindle motor 106, discs 108, spacers and clamping elements collectively form a disc stack 109.

An actuator assembly 110, also called a head stack assembly or an HSA, includes a central body 112 configured to rotate about a cartridge bearing assembly 114 affixed to the base deck 102. A number of rigid actuator arms 116 extend from the central body 112 into the disc stack 109. Flexible suspension assemblies 118, also called flexures, extend from the arms 112 to support an array of data transducer heads 120.

While a single disc 108 and attendant data transducer heads 120 can be used, it is contemplated for purposes of the present discussion that the disc drive 100 includes a plurality of discs 108 and data transducer heads 120. Actuator arms 1116 support the data transducer heads 120, with the top actuator arm 116 extending above the disc stack 109, as shown in FIG. 1, and the bottom actuator arm 116 extending below the disc stack 109. Each of the intermediary actuator arms 116, which extend between the discs 108, supports two flexures 118 and two data transducer heads 120.

The actuator assembly 110 is pivotally moved through the application of electrical current to a coil 122 of a voice coil motor (VCM) 124. When in a non-operational state, as shown in FIG. 1, the actuator assembly 110 is latched in a parked position by a toggle latch 126 and the data transducer heads 120 contact textured landing zones 128 (denoted by broken line) defined on the disc surfaces near the innermost diameters of the discs 108.

A flex circuit assembly 129 passes electrical signals between the head stack assembly 110 and a disc drive printed circuit board 131, also referred to as a PCB, and which supports communication and control electronics for the disc drive 100. The PCB 131 in FIG. 1 is mounted to the underside of the base deck 102.

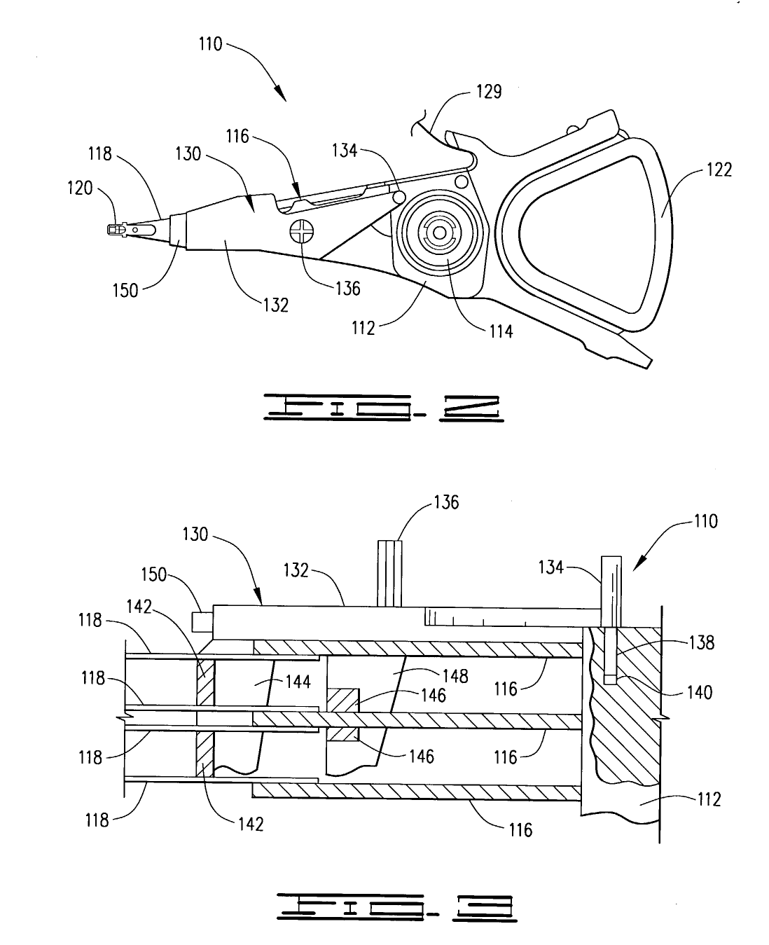

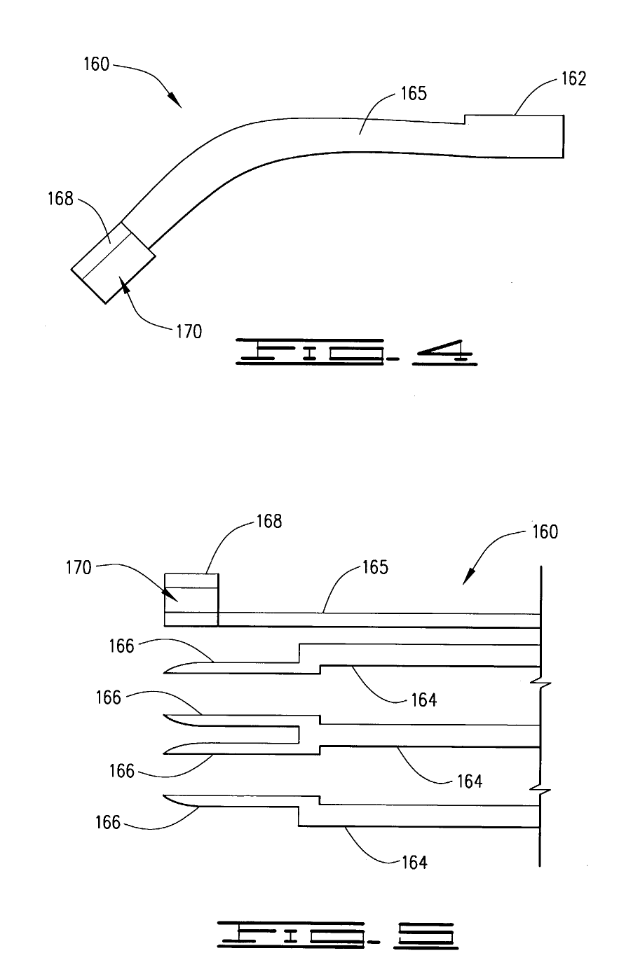

FIG. 2 shows the actuator assembly 110 of FIG. 1 prior to installation onto the base deck 102. A vendor usually provides the actuator assembly 110 with a shipping spacer 130 to protect it from damage during shipping and handling. As shown in FIG. 3, the shipping spacer 130 includes a main body portion 132 that extends along and is supported by the top surface of the top actuator arm 116. First and second alignment posts 134, 136 extend upwardly from the main body portion 132 as shown for manipulation of the shipping spacer 130. An alignment peg 138 extends downwardly from the first alignment post 134 and is inserted into a tooling bore 140 in the central body 112 of the actuator assembly 110.

The shipping spacer 130 further includes spacer members 142 (shown partially cut-away in FIG. 3) that extend between adjacent pairs of the flexures 118 to support the flexures in a desired spaced relationship. A spacer support arm 144 that extends downwardly from the main body portion 132 supports the spacer members 142. Actuator arm clip members 146 (also shown partially cut-away) are supported by a clip support arm 148 and are positioned to pressingly engage the intermediary actuator arm 116 as shown. A shipping spacer alignment tab 150 projects from a distal end of the main body portion 132 and is engaged during the merging of the actuator assembly 110 with the disc stack 109 for the purpose explained below.

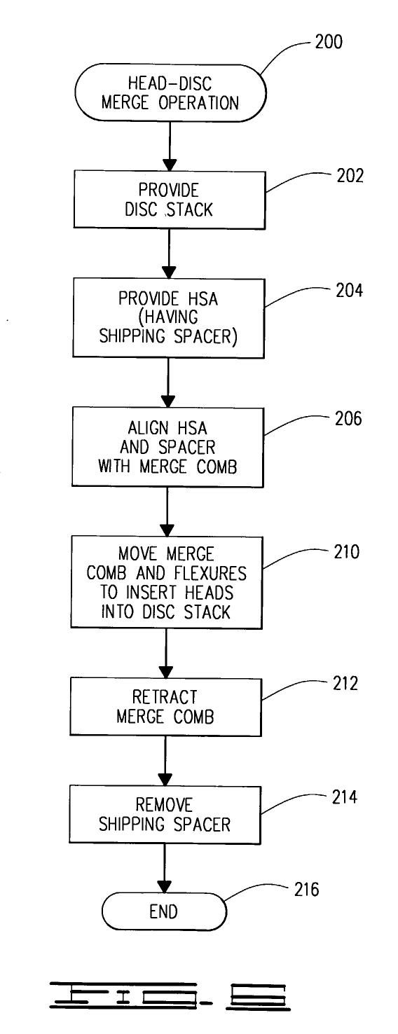

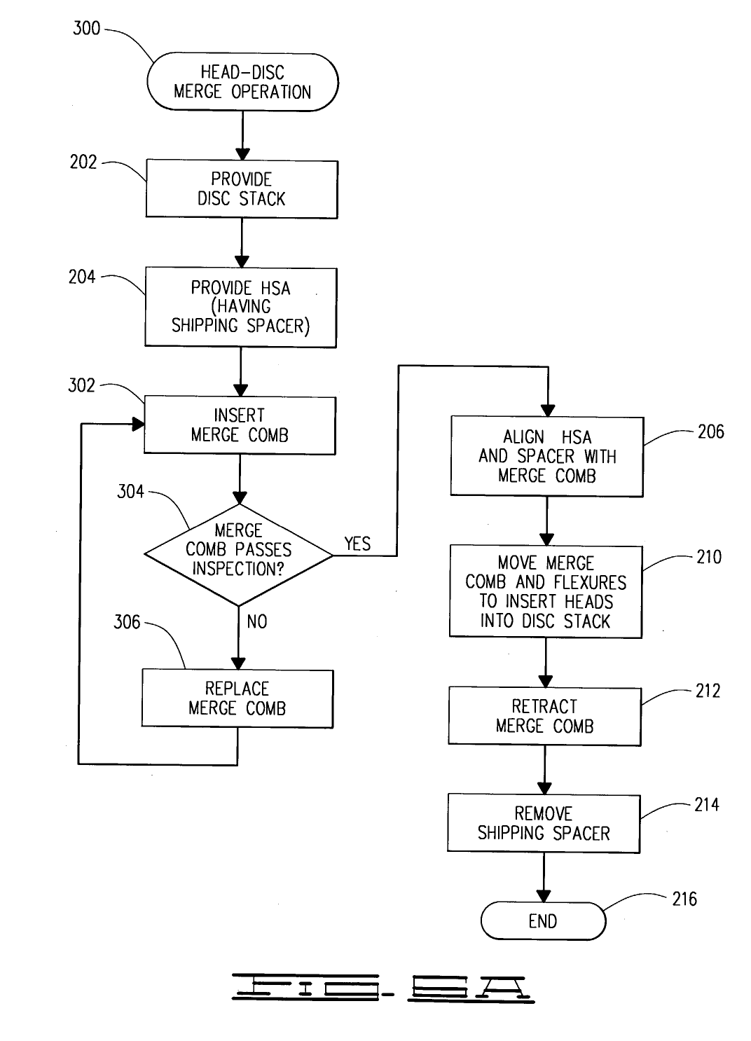

A merge comb 160, also referred to as a merge tool or a merge spreader, is shown in FIGS. 4 and 5. Preferably, a robotic arm, not shown in these figures, is connected to the merge comb 160 to merge the actuator assembly 110 with the disc stack 109. The merge comb 160 includes a main body portion 162 and a number of rigid merge arms 164 that extend from the main body portion 162, and when a shipping spacer 130 is present, an upper merger arm 165 extends from the main body portion 162 substantially parallel to the top merge arm 164. Each intermediate merge arm 164 supports a pair of flexure support finger members 166, as shown, while each of the upper and lower merge arms 164 supports a single flexure support tooth member 166.

A top merge arm 165 supports an alignment body portion 168 that defines a U-shaped channel 170, which is sized to accommodate the shipping spacer alignment tab 150 (FIG. 3). The alignment tab 150 and the channel 170 are preferably configured with appropriate beveled edges to allow precise alignment and passage of the alignment tab 150 into and through the channel 170 during the merge operation. The shipping spacer 130 and the merge comb 160 are sometimes collectively referred to as a merge assembly.

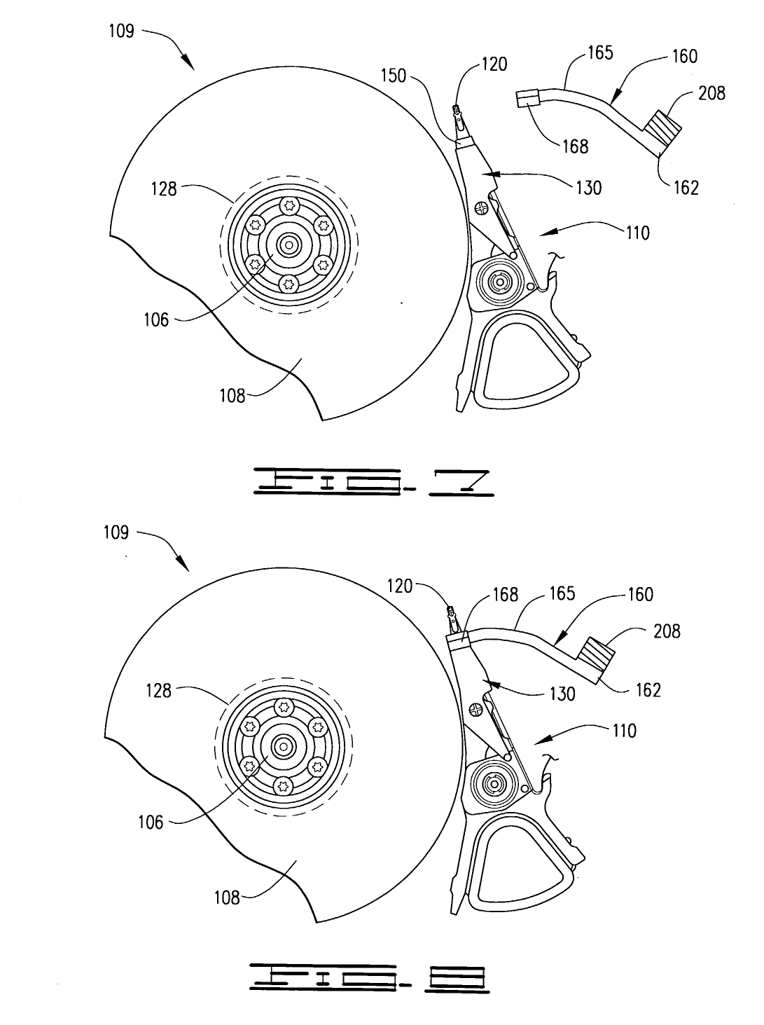

FIG. 6 is a flow chart for a head disc merge operation 200 carried out as will now be described. Initially, a disc stack (such as the disc stack 109) is provided at step 202 and an actuator assembly (such as the actuator assembly 110) with a shipping spacer (such as the shipping spacer 130) is provided at step 204.

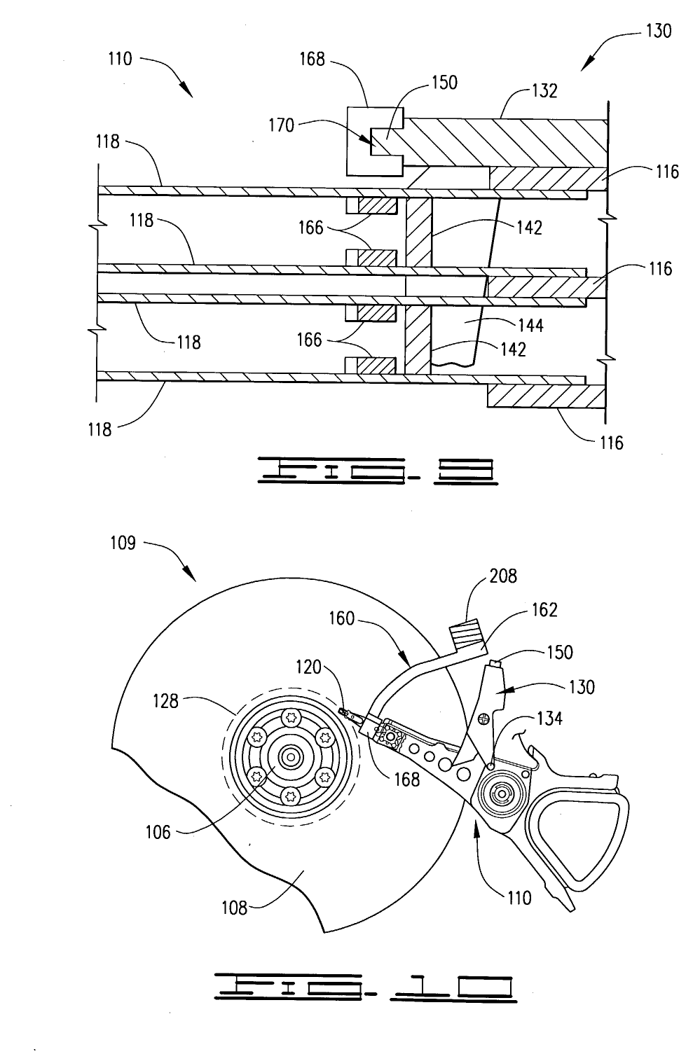

The disc stack 109 and the actuator assembly 110 will generally have a respective orientation at this point as shown in FIG. 7, with the data transducer heads 120 at a position beyond the outermost diameter of the disc stack 109. The disc stack 109 and the actuator assembly 110 are preferably mounted to the base deck 102 at this time. However, this is not limiting since the merge operation can alternatively be carried out prior to attachment of the actuator assembly 110 and the disc stack 109 to the base deck 102.

Continuing with the flow chart of FIG. 6, at step 206, a merge comb (such as the merge comb 160) is advanced to align with the actuator assembly 110 and the shipping spacer 130, as shown in FIG. 8. Preferably, a robotic arm 208 (shown in partial cross-section) is affixed to the main body 162 of the merge comb 160, and the robotic arm 208 serves to advance the merge comb 160.

The alignment of the actuator assembly 110 and its shipping spacer 130 with the merge comb 160 during step 206 results in the insertion of the shipping spacer alignment tab 150 into the merge comb alignment channel 170, and the placement of the flexure support members 142 into respective positions to support the flexures 118 as illustrated by FIG. 9.

The elevation of the merge comb 160 is preferably controlled with respect to the measured elevation of the disc stack 109 so that, as the shipping spacer alignment tab 150 is passed into the merge comb alignment channel 170, the elevational orientation of the shipping spacer 130 places the flexures 118 in alignment with the flex support finger members 166 and with the discs 108.

In this way, damage is averted as flex support finger members 166 of the merge comb 160 are brought into appropriate alignment with the discs 108. The flexures 118, typically made of spring steel, can be deformed beyond their elastic limit should the distal ends of the flex support finger members 166 mechanically interfere with the edges of the flexures 118. Severe damage can occur if the flex support finger members 166 fail to pass as intended along the sides of the respective flexures 118. Also, once the flex support finger members 166 correctly align and support the flexures 118, it is important that subsequent advancement of the merge comb 160 into the disc stack 109 occur without contact between the data transducer heads 120 and the discs 108. The material and dimensions of the merge comb 160 is preferably selected to ensure proper alignment of the channel 170 with the alignment tab 150, thereby maintaining the desired relative alignment of the flex support finger members 166.

Continuing with the flow chart of FIG. 6 at step 210, the merge comb 160 is next used to advance the data transducer heads 120 to the desired final park position, as shown in FIG. 10. As the merge comb 160 is advanced beyond the orientation shown in FIGS. 8 and 9, the shipping spacer 130 will come into contact with the outer edges of the discs 108, and the shipping spacer 130 will be moved aside by the outer edges of the discs 108, as shown in FIG. 10.

More particularly, the clip members 146 of the shipping spacer 130 will disengage from the intermediary actuator arms 116, the flexure support members 142 will disengage from the flexures 118, and the alignment tab 150 will pass through the channel 170. The alignment peg 138 (FIG. 3) remains engaged in the tooling bore 140, and the shipping spacer 130 will remain outside the perimeter of the disc stack 109 while the actuator assembly 110 pivots to the park position, shown in FIG. 10.

With the merge operation completed, the latch 126 is caused to secure the actuator assembly 110 in the parked position, and the merge comb 160 is retracted at step 212 of FIG. 6. If desired, the merge operation can be performed while the disc stack 109 is not attached to the base deck 102; in such a case, the actuator assembly 110 can be supported in a fixed position during the merging process by a suitable fixture that need not be described herein.

As the flex support finger members 166 pull away from the flexures 118, the spring forces imparted by the flexures 118 will cause the data transducer heads 120 to be pressed into abutment with the landing zones 128. The shipping spacer 130 is then removed from the actuator assembly 110 at step 214 and the merge routine is completed as indicated at step 216.

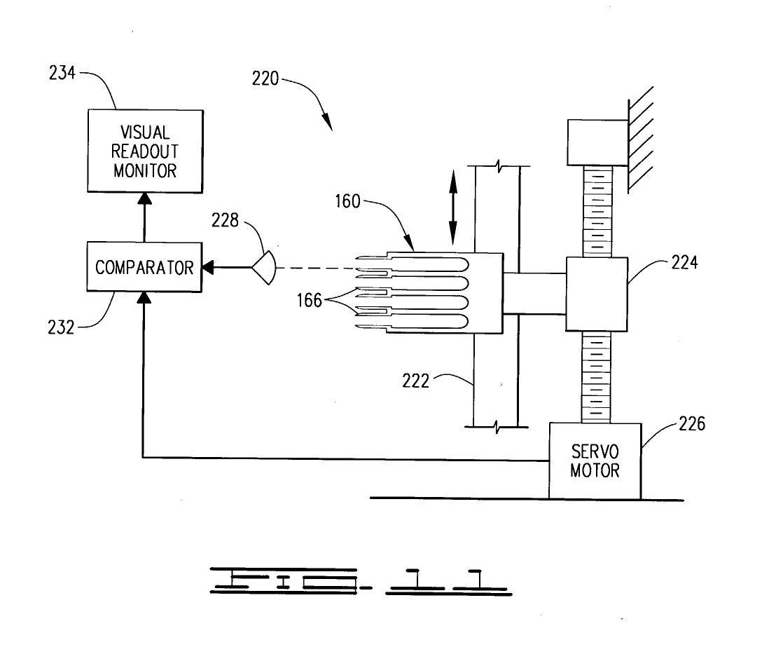

Turning now to FIG. 11, shown therein is an automatic merge inspection station 220 constructed in accordance with preferred embodiments of the present invention. The merge inspection station 220 depicts the merge comb 160 mounted on a vertical slide 222 and attached to a ball screw 224 driven by a servomotor 226. It will be understood that other structure will be required for appropriately supporting the merge comb 160 to rotate it in a horizontal plane as described hereinabove and as illustrated in FIGS. 7, 8 and 10; however, it is sufficient for the present teaching to refer to the diagrammatical representation of FIG. 11 for the vertical movement of the merge comb 160.

The merge inspection station 220 has an edge detector means 228 that forms an edge or surface detecting boundary 230. The edge detector means 228 can be one or more conventional photoelectric devices, each having an emitter and a receiver, or any equivalent device that emits and forms a detecting boundary, and which provides a signal to a comparator 232 when traversed by a physical member.

In the present instance, as the merge comb 160 is moved past the detector means 228, the finger members 166 passing the detecting boundary of the edge detector means 228 that provides transition readings in the form of electrical signals to the comparator 228. As desired, the comparator 228 can have a circuit with a microprocessor having stored therein acceptable values of the merge inspection station 220 that are necessary for the merge comb 160 to be considered acceptable for the merging operation. Preferably, however, it is sufficient that the edge detector means 228 provide signals responsive to the emitter transitions as the finger members 166 traverse the detecting boundary 230, and together with travel distance input from the servomotor 226, the precise dimensional values of each of the flexure support finger member 166 can be determined. The relative position, or elevation, of each flexure support finger member 166 can then be determined by the comparator, and a calculation is made to determine whether the flexure support finger members 166 and the supporting merger arms 164 have retained their dimensional values within specification tolerances.

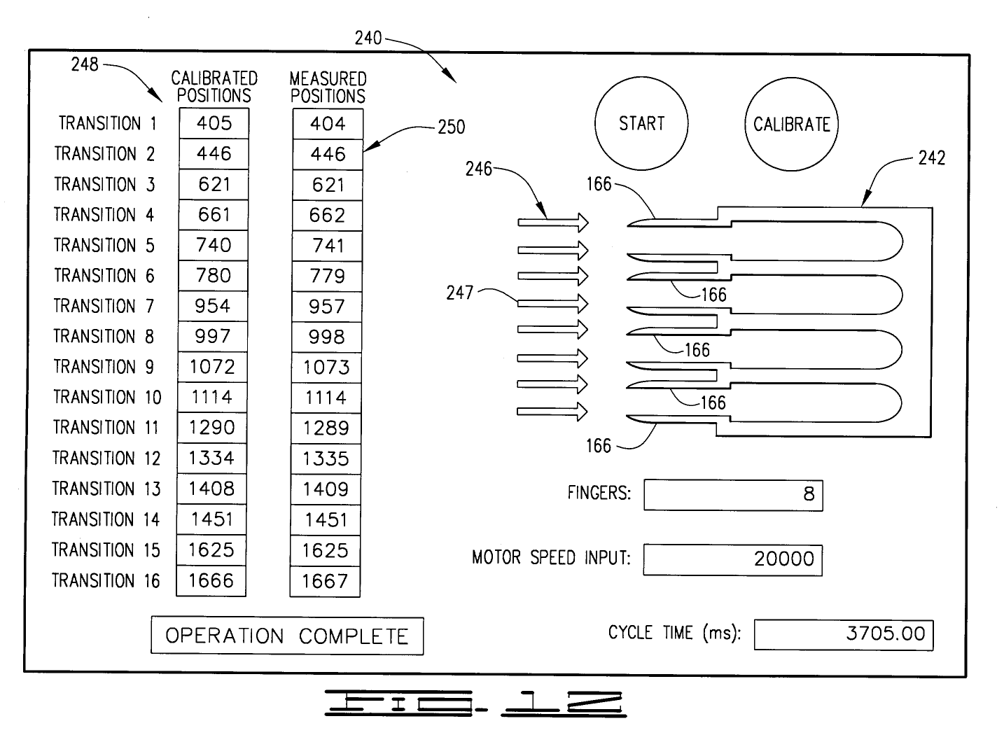

The dimensional values generated by the comparator 232 responsive to the edge detector means 228 can be fed to a visual readout monitor 234. FIG. 12 shows a screen readout 240 that has a merge comb profile field 242, which preferably conforms to the actual profile of the merge comb 160. The screen readout can be programmed to change the merge comb profile 232 to exhibit any number of profiles to be configured as representative of the tool being monitored by the merge inspection station 220.

The screen readout 230 also has a stacked array of arrow fields 246, each such arrow field pointing to an edge of one of the flexure support fingers 166 members represented in the merger comb profile field 242. A stacked array of target dimensions fields 248 and a juxtapositoned, stacked array of actual dimensions fields 250 are provided.

Displayed within the target dimensions fields 248 are the maximum dimensional values, or elevational locations of, the corresponding edges of each of the flexure support finger members 166 of the merge comb 160. Displayed within the actual dimensions fields 250 are the actual measured dimensional values, or the elevational locations of, the corresponding edges of each of the flexure support finger members 166 of the merge comb 160.

When the measured dimensional values are displayed in the actual dimensions fields 250, the programming is determined to illuminate the arrow fields 246, such as at arrow field 247, that correspond to unacceptable conditions, thereby publishing notification of an out of spec condition and information of which flexure support finger members. 166, if any, are out of spec. Preferably, when the comparator 232 determines that the inspected merge comb 160 deviates from an accepted nominal, it will also initiate an appropriate sound alarm and shut down the merging operation by an appropriate circuit (not shown).

Once the merging operation is halted due to a finding of an unacceptable merge comb, the out of spec merge comb 160 can be removed and replaced with another merge comb 160. As will be made clear from below, the merge operation will not proceed until the replacement merge comb 160 is then found to meet the programmed specification by the merge inspection station 220.

A flow chart showing a head disc merge operation 300 carried out according to preferred embodiments of the present invention is shown in FIG. 6A. As with the above described merge operation 200 (FIG. 6), the disc stack (such as the disc stack 109) is provided at step 202 and an actuator assembly (such as the actuator assembly 110) with a shipping spacer (such as the shipping spacer 130) is provided at step 204. As above, there are applications in which a shipping spacer may not be present, and as such, the presence or absence of a shipping spacer will have no bearing on the merge inspection station 220.

The disc stack 109 and the actuator assembly 110 will generally have a respective orientation at this point as shown in FIG. 7, with the data transducer heads 120 at a position beyond the outermost diameter of the disc stack 109. The disc stack 109 and the actuator assembly 110 are preferably mounted to the base deck 102 at this time. However, this is not limiting since the merge operation can alternatively be carried out prior to attachment of the actuator assembly 110 and disc stack 109 to the base deck 102.

Continuing with the flow chart of FIG. 6A, the merge comb 160 is inspected as indicated at step 302 by the merge inspection station 220 in the manner described hereinabove. As indicated at step 304, if the merge comb 160 does not pass inspection at the merge station 220, the defective merge comb 160 is replaced at step 306. The replacement merge comb 160 is then moved vertically to the merge inspection station 220 for inspection as indicated at step 302. If the replacement merge comb 160 passes inspection as at step 304, the replacement merge comb 160 is advanced at step 206 to align with the actuator assembly 110 (FIG. 8) by the robotic arm 208. It will be understood that an occasional replacement merge comb 160 will not pass the inspection of step 302, but each replacement comb is subjected to the inspection step 302, and the merging operation 300 will not proceed until a replacement merge comb 160 is determined to be acceptable.

The alignment of the actuator assembly 110 and the shipping spacer 130 with the merge comb 160 during step 206 results in the insertion of the shipping spacer alignment tab 150 into the merge comb alignment channel 170, and the placement of the flexure support members 142 into respective positions to support the flexures 118 (FIG. 9). The shipping spacer alignment tab 150 enters the merge comb alignment channel 170, the elevational orientation of the shipping spacer 130 having been adjusted to place the flexures 118 in an appropriate alignment with the flex support finger members 166 and with the discs 108.

As mentioned above, prior inspection of the merge comb 166 before each merge insertion cycle assures that potential damage is averted as the flex support finger members 166 of the merge comb 160 are brought into appropriate alignment with the discs 108. That is, mechanical interference is avoided between the flexures 118 and the discs 108, as subsequent advancement of the merge comb 160 into the disc stack 109 will occur without contact between the data transducer heads 120 and the discs 108.

Continuing with the flow chart of FIG. 6A at step 210, the merge comb 160 is next used to advance the data transducer heads 120 to the desired final parked position (FIG. 10). As the merge comb 160 is advanced beyond the orientation shown in FIGS. 8 and 9, the shipping spacer 130 will come into contact with the outer edges of the discs 108, and the shipping spacer 130 will be moved aside by the outer edges of the discs 108.

More particularly, the clip members 146 of the shipping spacer 130 will disengage from the intermediary actuator arms 116; the flexure support members 142 will disengage from the flexures 118; the alignment tab 150 will pass through the channel 170; and the shipping spacer 130 will remain outside the perimeter of the disc stack 109 while the actuator assembly 110 pivots to the parked position.

With the merge operation completed, the latch 126 is caused to secure the actuator assembly 110 in the parked position, and the merge comb 160 is retracted at step 212 of FIG. 6A. As mentioned above, the merge cycle can be performed, if desired, on the disc stack 109 while unattached to the base deck 102 by supporting the actuator assembly 110 in an appropriate fixture.

As the flex support finger members 166 pull away from the flexures 118, the spring forces imparted by the flexures 118 will cause the data transducer heads 120 to be pressed into abutment with the landing zones 128. The shipping spacer 130 is then removed from the actuator assembly 110 at step 214 and the merge routine is completed as indicated at step 216.

It is to be understood that even though numerous characteristics and advantages of various embodiments of the present invention have been set forth in the foregoing description, together with details of the structure and function of various embodiments of the invention, this detailed description is illustrative only, and changes may be made in detail, especially in matters of structure and arrangements of parts within the principles of the present invention to the full extent indicated by the broad general meaning of the terms in which the appended claims are expressed. For example, the particular elements may vary depending on the particular application of the merge comp inspection apparatus and method without departing from the spirit and scope of the present invention.

In addition, although the embodiments described herein are generally directed to a merge comb inspection apparatus and method for the manufacture of a disc drive data storage device, it will be appreciated by those skilled in the art that the merge comb inspection apparatus and method can be used for other types of data storage systems without departing from the spirit and scope of the claimed invention.

What is claimed is:

1. A head disc merge assembly station for merging an actuator assembly with a disc stack, the actuator assembly having a flexure supporting a data transducer head and the disc stack having a disc with a data storage surface, the head disc merge assembly comprising:
a merge comb having a merge arm engaging and supporting the flexure at an elevation sufficient to establish a clearing relationship between the head and the disc as the data transducer head is moved adjacent the data storage surface; and
a merge comb inspection device, wherein the merge arm is measured to determine the clearing relationship between the merge arm and the disc stack.

2. The head disc merge assembly of claim 1, wherein the merge comb inspection device comprises:
an edge detector; and
means for moving the merge comb relative to the edge detector to determine selected dimensions of the merge comb;
comparator means for determining whether the merge comb has clearing engagement the disc stack.

3. The head disc merge assembly of claim 2, wherein the merge comb inspection station further comprises:
a readout monitor to provide notification of an out of specification condition of the merge comb.

4. The head disc merge assembly of claim 3, wherein the merger arm has a flexure support finger member at one end thereof, the flexure support finger member configured to engage and position the flexure as the merge comb is moved toward the flexure.

5. The head disc merge assembly of claim 4, wherein the merge comb is configured to place the data transducer head at a textured landing zone on the data storage surface, thereafter to retract to a position beyond an outermost diameter of the data storage surface, the data transmission head remaining on the landing zone.

6. The head disc merge assembly of claim 5, wherein the merge comb inspection device is positioned to measure the relative elevation between the merge comb and the disc stack when the merge comb is at the retract position.

7. A merge assembly for merging an actuator assembly with a disc stack, the actuator assembly having at least one flexure supporting a data transducer head and the disc stack having a disc with data storage surfaces, the merge assembly comprising:
a merge comb having a flexure support member to support the flexure at a predetermined elevation with respect to the data storage surface sufficient to allow the flexure support member to be advanced while positioning the data transducer head in clearing relationship between the head and the disc as the head is moved adjacent the data storage surface; and
a merge comb inspection station comprising:
edge detector means for determining selected dimensions of the merge comb; and
comparator means receiving the selected dimensions, the comparator means determining whether the merge comb has clearing engagement with the disc stack.

8. The head disc merge assembly of claim 7, wherein the merge comb inspection station further comprises:
a readout monitor to provide notification of an out of specification condition of the merge comb.

9. The merge assembly of claim 8, wherein the flexure support member has one end thereof configured to engage and position the flexure as the merge comb is moved toward the flexure.

10. The merge assembly of claim 9 wherein the edge detector means comprises:
an edge detector forming an edge detecting boundary;
positioning means for moving the merge comb relative to the edge detector so that the flex support member traverses the edge detecting boundary, the edge detector generating edge position signals proportional to the selected dimensions of the merge comb.

11. The merge assembly of claim 10 wherein the positioning means is further characterized as aligning the merger comb with the disc stack, moving the data transmission head to a position over a textured landing zone on the data storage surface and thereafter moving the merger comb to a retract position beyond an outermost diameter of the data storage surface, the data transmission head remaining on the landing zone.

12. A merger inspection station for determining the spacing of flexure support members of a merge comb comprising:
edge detector means for determining selected dimensional values of a merge comb used to separate and position the flexure support members during an assembly process;
comparator means for comparing the dimensional values against predetermined nominal selected values; and
readout monitor means for displaying the results of the comparator means.

13. The merge inspection station of claim 12, wherein the edge detector means comprises:
an edge detector forming a surface detecting boundary; and
positioning means for moving the merge comb relative to the edge detector so that the flex support members traverse the edge detecting boundary, the edge detector generating surface position signals proportionate to the selected dimensional values.

14. The merge inspection station of claim 13, wherein the positioning means is further characterized as comprising an aligning the merge comb with discs so that the flexure support members can selectively traverse the surfaces of the discs.

15. A method of merging an actuator assembly with a disc stack, the actuator assembly having a flexure supporting a data transducer head and the disc stack having a disc with a data storage surface, the method comprising:
(a) passing the actuator assembly to a head disc merge assembly station having a merge comb with a merge arm for engaging and supporting the flexure at an elevation sufficient to establish a clearing relationship between the head and the disc as the data transducer head is moved adjacent the data storage surface;
(b) moving the merge comb to an inspection station;
(c) measuring selected dimensional values of the merge comb;
(d) comparing the selected dimensional values to nominal values to determine one of acceptable merge comb elevations or unaccepted merge comb elevations;
(e) if acceptable merge comb elevations are determined, aligning and engaging the merge comb and the actuator assembly; and
(f) moving the merge comb to merge the actuator assembly with the disc stack.

16. The method of claim 15 wherein unaccepted merge comb elevations are determined in the comparing step, and further comprising the steps of:
(g) replacing the merge comb with a replacement merge comb;
(h) repeating steps (b) through (f).

17. The head disc merge assembly of claim 15, wherein following step (d) the method further comprising:
displaying the results from step (d) on a readout monitor to provide visual notification of an out of specification condition of the merge comb.

18. The head disc merge assembly of claim 17, wherein the merger arm has a flexure support finger member at one end thereof, the flexure support finger member configured to engage and position the flexure as the merge comb moves the actuator assembly.

19. The head disc merge assembly of claim 18, wherein the merge comb is configured to place the data transducer head at a textured landing zone on the data storage surface and thereafter to retract to a position beyond an outermost diameter of the data storage surface, the data transmission head remaining on the landing zone.

20. The head disc merge assembly of claim 19, wherein the merge comb inspection device is positioned to measure the relative elevation between the merge comb and the disc stack when the merge comb is at the retract position.
